(19) United States
(12) Patent Application Publication
(10) Pub. No.: US 2022/0158204 A1
(43) Pub. Date: May 19, 2022

(54) CATALYTIC HEATERS FOR EVAPORATIVELY COOLED FUEL CELL SYSTEMS

(71) Applicant: Intelligent Energy Limited, Loughborough, Leicestershire (GB)

(72) Inventors: Anand Stephen Chellappa, Leicester (GB); Chris Dudfield, Leicester (GB)

(73) Assignee: Intelligent Energy Limited, Loughborough, Leicestershire (GB)

(21) Appl. No.: 17/441,268

(22) PCT Filed: Mar. 13, 2020
(86) PCT No.: PCT/GB2020/050642

§ 371 Date: Sep. 20, 2021

(30) Foreign Application Priority Data
Mar. 21, 2019 (GB) 19038801

(51) Int. Cl. H01M 8/04223; H01M 8/04029; H01M 8/04014; H01M 8/04701

(52) U.S. Cl. CPC H01M 8/04253; H01M 8/04029; H01M 8/04723; H01M 8/04268; H01M 8/04022

(57) ABSTRACT

Disclosed herein are aspects of fuel cell systems (10) and methods having a fuel cell assembly (20); a coolant module (30) configured to provide coolant to the fuel cell assembly, the coolant module comprising a coolant storage (32) tank fluidly connected to the fuel cell assembly (20) and a coolant tank heater comprising one or more catalytic heating elements (55) arranged proximate to the coolant storage tank (32) to heat the coolant, wherein the one or more catalytic heating elements (55) includes a catalyst material that combusts hydrogen and ignites spontaneously.

This application is the US National Phase of International application No. PCT/GB2020/050642, filed Mar. 13, 2020, titled CATALYTIC HEATERS FOR EVAPORATIVELY COOLED FUEL CELL SYSTEMS, which claims the benefit of Great GB 1903880.1, filed Mar. 21, 2019, the contents of which are incorporated by reference herein in their entirety.

### TECHNICAL FIELD

The present disclosure relates generally to a fuel cell system and more particularly to a fuel cell system with a catalytic heater for heating a coolant supply configured to utilize the anode exhaust stream for combustion.

### BACKGROUND

Fuel cells generate electricity by an electrochemical reaction between a fuel gas and an oxidizing gas. The fuel gas is often hydrogen and the oxidizing gas is air. Metals such as palladium and platinum are used as catalysts to cause the electrochemical reaction between the fuel gas and the oxidizing gas.

Conventional electrochemical fuel cells convert fuel and oxidant into electrical energy and a reaction product. A common type of electrochemical fuel cell comprises a membrane electrode assembly (MEA), which includes a polymeric ion (proton) transfer membrane between an anode and a cathode and gas diffusion structures. The fuel, such as hydrogen, and the oxidant, such as oxygen from air, are passed over respective sides of the MEA to generate electrical energy and water as the reaction product. A stack may be formed comprising a number of such fuel cells arranged with separate anode and cathode fluid flow paths. Such a stack is typically in the form of a block comprising numerous individual fuel cell plates held together by end plates at either end of the stack.

It is important that the polymeric ion transfer membrane remains hydrated for efficient operation. It is also important that the temperature of the stack is controlled. Thus, coolant may be supplied to the stack for cooling and/or hydration. Accordingly, a fuel cell system may include a water/coolant storage tank for storing water for hydration and/or cooling of the fuel cell stack, for example. If the fuel cell system is stored or operated in sub-zero conditions, the water in the fuel cell stack and water storage tank may freeze. The frozen water may cause blockages that hinder the supply of coolant or hydration water to the fuel cell stack. This is a particular problem when the fuel cell system is off and therefore water in the water storage tank is no longer heated by its passage through the stack and may freeze completely. In such an event, sufficient liquid water may not be available for hydration and/or cooling. This may prevent the fuel cell assembly from being restarted or operating at full power until the frozen water has been thawed. It is known to provide a heater in the fuel cell system, which operates on stored energy, such as from a battery, and maintains the fuel cell system at above-zero temperatures to prevent freezing occurring. The battery power is, however, limited and the fuel cell system may experience freezing if the battery fails or becomes discharged. Furthermore, electrical resistance heating elements are often used. Electrical resistance heating, however, takes time to heat up to its optimum temperatures and provides a drain on the system.

### SUMMARY

In accordance with some aspect of the disclosure, a fuel cell system and method of use is disclosed which includes a method, to liberate fluid coolant via a coolant module configured to supply a coolant to a fuel cell assembly from a coolant storage tank and having one or more catalytic heating elements arranged proximate to the coolant storage tank configured to supply heat to a restricted flow coolant; and, wherein the catalytic heating elements include at least a catalyst material that combusts hydrogen on contact.

In accordance with some aspect of the disclosure, a fuel cell system and method of use is disclosed which includes a fuel cell assembly having an anode inlet, a cathode inlet, an anode exhaust and a cathode exhaust; a coolant module configured to provide coolant to the fuel cell assembly; the coolant module further comprising; a coolant tank configured to store coolant; the coolant tank having inner and outer walls and fluidly connected to the fuel cell assembly; at least one coolant tank heater containing one or more catalytic heating elements arranged in a heat exchange relationship with the coolant storage tank; the catalytic heating elements having a catalytic material therein; and, a means to provide a gaseous fuel supply, for spontaneous catalytic combustion, to the coolant tank heater. In some instances, the coolant is water and the gaseous fuel supply includes hydrogen. In some instances, the catalyst material provides combustion of hydrogen gas at temperatures at or below −30 degrees C.

In accordance with some aspect of the disclosure, a fuel cell system and method of use is disclosed which includes a fuel cell assembly having an anode inlet, a cathode inlet, an anode exhaust and a cathode exhaust; a coolant module configured to provide coolant to the fuel cell assembly; the coolant module further comprising; a coolant tank configured to store coolant; the coolant tank having inner and outer walls and fluidly connected to the fuel cell assembly; at least one coolant tank heater containing one or more catalytic heating elements arranged in a heat exchange relationship with the coolant storage tank; the catalytic heating elements having a catalytic material therein; and, a means to provide a gaseous fuel supply, for spontaneous catalytic combustion, to the coolant tank heater. In some instances, the catalyst material comprises a platinum group metal or alloy. In some instances, the catalyst material comprises palladium group or an alloy thereof. In some instances, the catalyst material is presented on a metallic or ceramic substrate. In some instances, the substrate is one of metal foam, wire and wire mesh.

In accordance with some aspect of the disclosure, a fuel cell system and method of use is disclosed which includes a fuel cell assembly having an anode inlet, a cathode inlet, an anode exhaust and a cathode exhaust; a coolant module configured to provide coolant to the fuel cell assembly; the coolant module further comprising; a coolant tank configured to store coolant; the coolant tank having inner and outer walls and fluidly connected to the fuel cell assembly; at least one coolant tank heater containing one or more catalytic heating elements arranged in a heat exchange relationship with the coolant storage tank; the catalytic heating elements having a catalytic material therein; and, a means to provide a gaseous fuel supply, for spontaneous catalytic combustion, to the coolant tank heater. In some instances, at least one catalytic heating element is mounted or fixed on portions of the inner wall. In some instances, at least one catalytic heating element is mounted or fixed on portions of the outer wall. In some instances, the coolant storage tank further comprises and outer jacket. In some instances, the catalytic heater operates independently of the fuel cell assembly. In some instances, an exhaust module is included. In Some instances, the exhaust module is configured to scrub the anode exhaust and remove hydrogen therein. In some instances, the exhaust module further includes an off-gas burner. In some instances, an absorber module packed with absorbent media is included wherein otherwise lost heat from off-gas combustion is captured and provided to regenerate the absorbent media

In accordance with some aspect of the disclosure, a fuel cell system and method of use is disclosed which includes a fuel cell assembly having a coolant module configured to provide coolant to the fuel cell assembly, the coolant module comprising a coolant storage tank fluidly connected to the fuel cell assembly and a coolant tank heater comprising one or more catalytic heating elements arranged proximate to the coolant storage tank to heat the coolant, wherein the one or more catalytic heating elements includes a catalyst material that combusts hydrogen and ignites spontaneously.

### BRIEF DESCRIPTION OF THE DRAWINGS

The above-mentioned and other features and advantages of this disclosure, and the manner of attaining them, will become apparent and be better understood by reference to the following description of aspects of the disclosure in conjunction with the accompanying drawings, wherein:

FIG. 1A is a schematic drawing of some aspects of a fuel cell system of the present disclosure.

FIG. 1B is partial schematic drawing of some aspects of a fuel cell system of the present disclosure.

FIG. 2 is a schematic drawing of a coolant storage module of the present disclosure.

FIG. 3 is a schematic drawing of aspects of a thermal module of the present disclosure.

FIG. 4-7 are aspects of several implementations of catalytic heaters within a coolant storage tank.

FIG. 8-10 are aspects of several implementations of a jacketed coolant storage tank and heater system.

### DETAILED DESCRIPTION

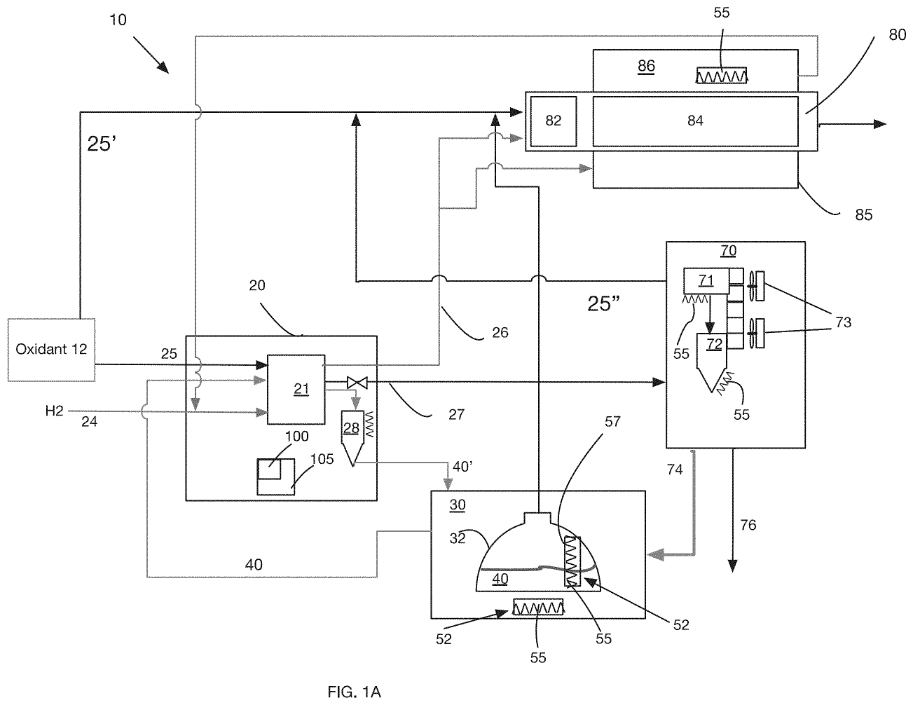

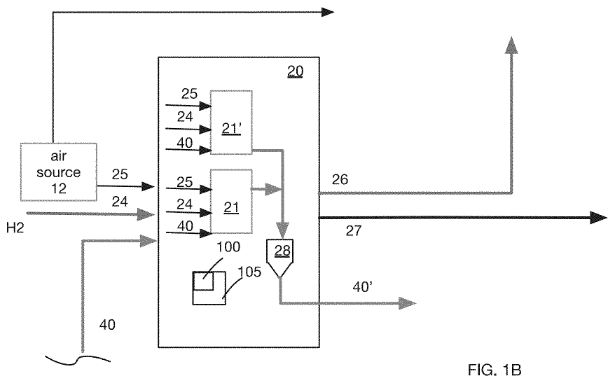

The present disclosure provides a fuel cell system using catalytic combustion to heat the coolant supply. FIG. 1A is schematic of a fuel cell system 10 including a fuel cell assembly 20 and a coolant storage module 30. The fuel cell assembly 20 includes one or more fuel cell stacks 21 including a plurality of proton exchange membrane fuel cells stacked together and the balance of plant BOP (not shown) including pumps, valves, fans, controllers and circuitry and the like which are well known in the art. The fuel cell assembly 20 shown is an evaporatively cooled fuel cell assembly. In this example, the coolant comprises water, although it will be appreciated that other coolants could be used such as glycol, water or other or aqueous solutions. The coolant or water storage module 30, in this example, stores pure water for the hydration and/or evaporative cooling of the fuel cell assembly 20. The coolant storage module 30 includes a coolant storage tank 32 to hold the coolant supply 40. The coolant storage tank is formed of a material which is impervious to leakage and corrosion. Suitable materials include, but are not limited to, Polymers such as PTFE, PVDF, PA, PE, PEEK, PP and metals such as austenitic steel; series 6000 aluminum; titanium.

FIG. 1B shows a multiple stack configuration within the fuel cell assembly. In such a configuration, depending on the operational and design considerations, either a single coolant storage module 30 will be in fluid connection with all stacks or single coolant storage modules may be in fluid connection with one stack each.

In the event of freezing conditions, the coolant supply (which may be water) 40 in the coolant module 30 may freeze. The system 10 may not include or may not use an auxiliary heater to maintain an above-freezing temperature while the system 10 is powered down. On restarting the system 10, if water is the coolant, it may be required for cooling the fuel cell stack(s) and/or hydration of fuel cell membranes within said stack. Thus, if water is the selected coolant 40 in the tank 32 and it is frozen, it must be thawed quickly so that it is available to the stack(s) when the coolant is in a frozen or non-liquid state wherein it cannot flow freely it may be referred to as restricted flow coolant. The system 10 disclosed does not require any external low voltage or high voltage supply and operates to make liquid coolant available under its own generated power. This is advantageous as the power required to melt the ice is derived from the stack rather than by draining a battery. It is known that batteries may experience low performance in cold temperatures and therefore using the fuel cell assembly 20 power is therefore beneficial.

The fuel cell assembly 20 and stack(s) within are configured to receive fuel and oxidant. FIG. 1B show a schematic view of an array or grouping of fuel cell stacks 21 and 21′ within a single fuel cell assembly 20 and are configured to operate within the systems as described with respect to FIG. 1A and FIGS. 2-10.

The flow of fuel, such as hydrogen, is through an anode inlet 24 and a flow of oxidant, such as air, through a cathode inlet 25. An anode exhaust 26 is provided to allow for through flow of the fuel. A cathode exhaust 27 is provided to allow for through flow of the oxidant. It will be appreciated that the exhaust flows also carry some reaction by-products and any coolant/hydration liquid that may have passed through the assembly 20. The cathode exhaust 27 may include a coolant separator 28 to separate the produced water and coolant (water) 40′ from the cathode exhaust flow. The separated water is stored in the coolant storage module 30. It will be appreciated that while this example shows the recycling of water (coolant) that has passed through the stack, this disclosure is applicable to systems that do not recycle coolant or recycle coolant in a different way.

The coolant storage module 30 is fluidly connected to the fuel cell assembly by conduits, although it will be appreciated that the module 30 may be integrated with the fuel cells in the stack. The coolant storage module 30 is connected to the cathode inlet 25 to allow for the introduction of coolant into the cathode flow for evaporative cooling of the fuel cell assembly 20. The coolant may be introduced to the stack by a separate conduit.

The coolant storage module 30 may comprise a plurality of coolant storage tanks configured to supply coolant to the fuel cell assembly and each having one or more heater elements be placed therein or placed remotely in a thermal module 70. The catalytic heating elements are powered by combustion and comprise a heat-dissipating element 52, which may include a resistive heater or heat pipe 54 or heat exchanger 56 which is configured to move heat from one part of the fuel cell system to another. Additionally, compressors that drive oxidant through the fuel cell assembly can get warm relatively quickly after start-up of the fuel cell assembly and therefore moving heat from the compressors within the oxidant (air source) 12 to the coolant storage module using a heat exchanger and working fluid and/or heat pipe (fluid connection) in some instances that heat may be released as exhaust and in other instances such as start-up that waste heat may be captured via the heat exchanger and configured to heat frozen coolant. Such functionality may be switchable from a start-up state to a not start-up state to select between exhausting heat and capturing heat. Additionally, in some instance the waste heat may be utilized within an energy recovery module.

A coolant injection flow controller 100 may form part of a fuel cell system controller 105 for controlling further operations of the fuel cell system.

Coolant Tank Heater/Catalytic Heater

The fuel cell system 10 includes at least one catalytic heater 52 that burns a combustion fuel by the catalysis of a combustion catalyst. The catalytic heater may be used to meet the heating demands of the system 10 in different ways. Traditional fuel cell systems have used electric heaters. Electric heaters, however, have disadvantages as noted including but not limited to battery drain and other parasitic losses.

The catalytic heater 52 includes one or more catalytic heating elements 55. The catalytic heater 52 may provide a housing 57 to contain the catalytic heating elements 55. The catalytic heating elements 55 include catalytic material for combustion. The catalytic material may be supported on a substrate. A variety of different structures for the catalytic heater 52 and catalytic heating elements 55 are contemplated by the disclosure.

Preferably, the catalytic heater 52 is independent of the fuel cell assembly 20. An independent catalytic heater 52 is able to continue to operate while the fuel cell assembly 20 is shutdown. This feature is particularly advantageous because the coolant temperature is maintained and not a function of the fuel cell operation. If the catalytic heater 52 is not independent of the fuel cell assembly, then the fuel cell start-up may be delayed in sub-zero operating ambient conditions.

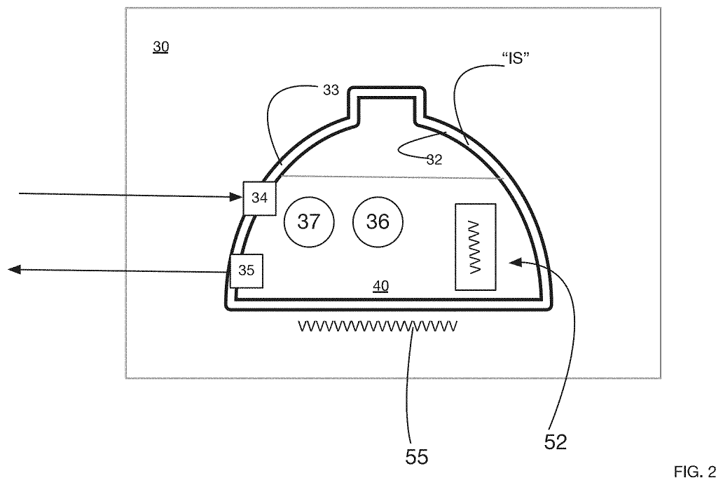

The coolant storage tank 32 illustrated in FIG. 2 holds the coolant supply 40. The coolant storage tank may include an outer layer 33. The outer layer may substantially enclose the coolant storage tank. The outer layer may be contoured and adhered to the coolant storage tank 32. The outer layer may be insulating to protect the temperature of the coolant storage tank and the coolant therein. The insulation may minimize any heat losses from the coolant supply. The outer layer may be rigid or flexible. The outer layer may be composed of a variety of suitable materials as discussed within.

The outer layer may define an interstitial space “IS” between the inner boundary of the outer layer and the outer boundary of the coolant storage tank. At least one of an insulator and a heat transfer material which may include metal foams, honeycombs, wax may be present in the interstitial space. Within the coolant storage tank one or more catalytic heater 52, fans 36 to exhaust vapor, and/or temperature sensors 37 to measure temperature. Additional catalytic heaters 55 may be located outside the coolant storage tank but in thermal communication with same.

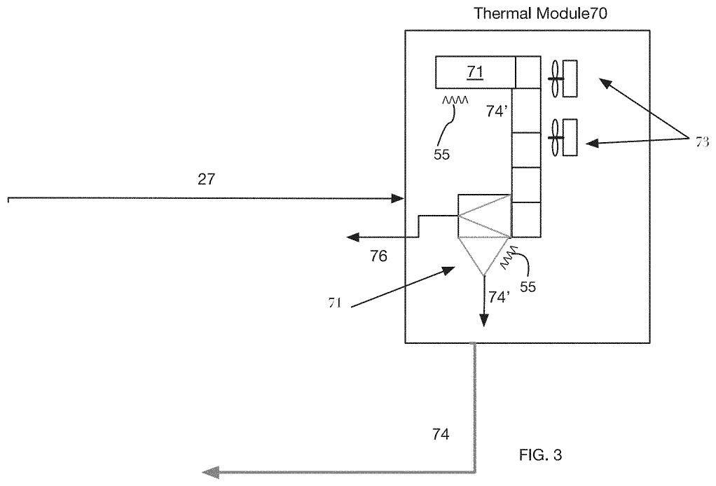

The thermal module shown in FIG. 3 is configured to recover water from the cathode exhaust 27 it is fluidly connected to the fuel cell assembly 20 and the coolant module 30.

Catalytic Heating Elements

FIGS. 4-7 show aspects of several implementations of catalytic heaters and heating elements within a coolant storage tank. In some instances, the heaters described below are periodically heated to ameliorate bacteria which may propagate in coolant if left untreated. In some instances, the heaters described below are affixed inside the tank and in yet other instances they may be affixed to the exterior of the tank but in thermal contact with the coolant through the tank.

FIG. 4 illustrates a coolant storage tank 32 containing coolant 40 and aspects of a U-shaped housing 60 with a catalytic heater 52 configured within the flow channel 61 within said housing 60. The housing provides a fluid pathway there through and is configured with an inlet 62 to receive a mixture of hydrogen (H2) and air 200. The H2 mixture may be provided from the hydrogen fuel tank, fuel feed line, waste stream such as anode purge or other suitable feed stream.

In some instances, depending on the pressure of the air and hydrogen (H2) feed stream a pump 64 may be added to maintain or achieve a desired pressure level. The hydrogen and air mixture travels through the flow channel 61 and interacts with the catalytic heating element 55 thereby producing heat from combustion of the hydrogen in said mixture. The resultant waste stream 210 exist the flow channel via an outlet 6.

Additionally, heat exchange structures such as extended fins “F” may be formed on the exterior of said housing 60.

An air and H2 mix of about 4%-74% H2, preferably outside the flammability limits of the mix, is feed into the catalytic heater 52. The catalyst as described below combusts the hydrogen thereby releasing heat during the reaction. The waste stream is removed via the outlet.

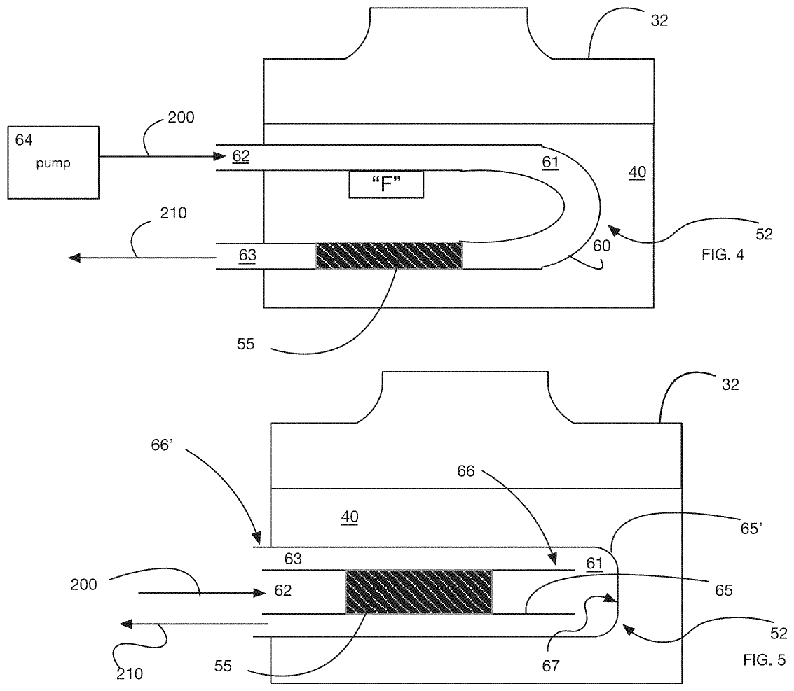

FIG. 5 illustrates a coolant storage tank 32 containing coolant 40 and aspects of a Tube within a Closed End Tube (TCET) housing 65 with a catalytic heater 52 configured within the flow channel 61 within said housing 65. The housing provides a fluid pathway there through and is configured with an inner flow channel 61 formed inside an open-ended tube 65 having a distal end 66 and a proximal end 66′. The distal end is fixed within a closed end tube 65′ whereby there is a gap between the end 67 of the closed end tube 65′ and the distal end 66 of the open-ended tube thereby forming a fluid connection between the open-ended tube and the close end tube. The hydrogen and air mixture enters the inlet 62 travels through the flow channel 61 and interacts with the catalytic heating element 55 thereby producing heat from combustion of the hydrogen in said mixture. The resultant waste stream 210 exist the flow channel via an outlet 63.

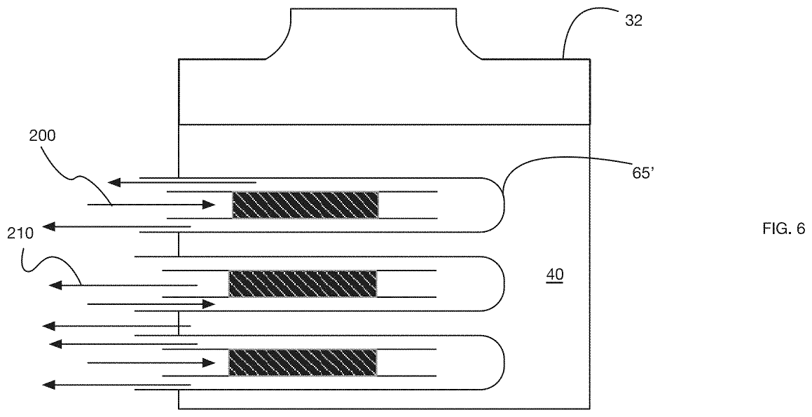

FIG. 6 illustrates a coolant storage tank 32 containing coolant 40 and aspects the combination of multiple TCET housings 65′ and corresponding inner open-ended tubes 65 with a catalytic heater 52 as described in reference to FIG. 5.

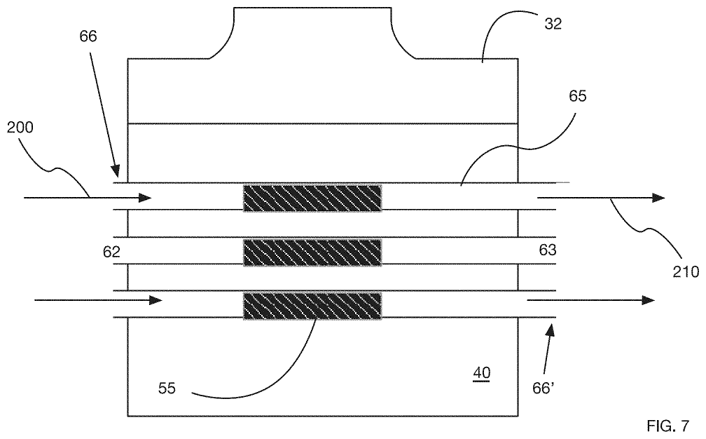

FIG. 7 illustrates a coolant storage tank 32 containing coolant 40 and aspects of multiple open-ended tube 65 having a distal end 66 and a proximal end 66′ with a catalytic heater 52 configured within a flow channel 61 within each open-ended tube housing. The housing provides a fluid pathway there through and is configured with an inlet 62 to receive a mixture of hydrogen (H2) and air 200. The H2 mixture may be provided from the hydrogen fuel tank, fuel feed line, waste stream such as anode purge. In some instances, depending on the pressure of the air and hydrogen (H2) feed stream a pump 64 may be added to maintain or achieve a desired pressure level. The hydrogen and air mixture travels through the flow channel 61 and interacts with the catalytic heating element 55 thereby producing heat from combustion of the hydrogen in said mixture. The resultant waste stream 210 exist the flow channel via an outlet 63.

The skilled artisan or one of ordinary skill in the art will understand the disclosure to encompass non-circular cross section flow channels. The use of “tube” as a description of the housing surrounding any part of a flow channel is not limiting and for the sake of brevity, rather than listing all potential cross-sectional forms tube is used to designate a surrounded or partially surrounded flow channel.

The illustration of a single catalytic heater within a coolant tank is not a limitation and the skilled artisan and those of ordinary skill in the art will recognize that the addition of additional catalytic heaters of homogeneous or non-homogeneous structure is within the scope of the disclosure.

The skilled artisan and those of ordinary skill in the art will recognize that one or more catalytic heating elements may be arranged to provide heat, via a heat exchange relationship with elements in addition to the coolant storage tank, such as an off-gas burner, and/or an anode exhaust absorber heater. Any system structure which may require heat to manage waste hydrogen in exhaust or to remove hydrogen via combustion from a feed stream.

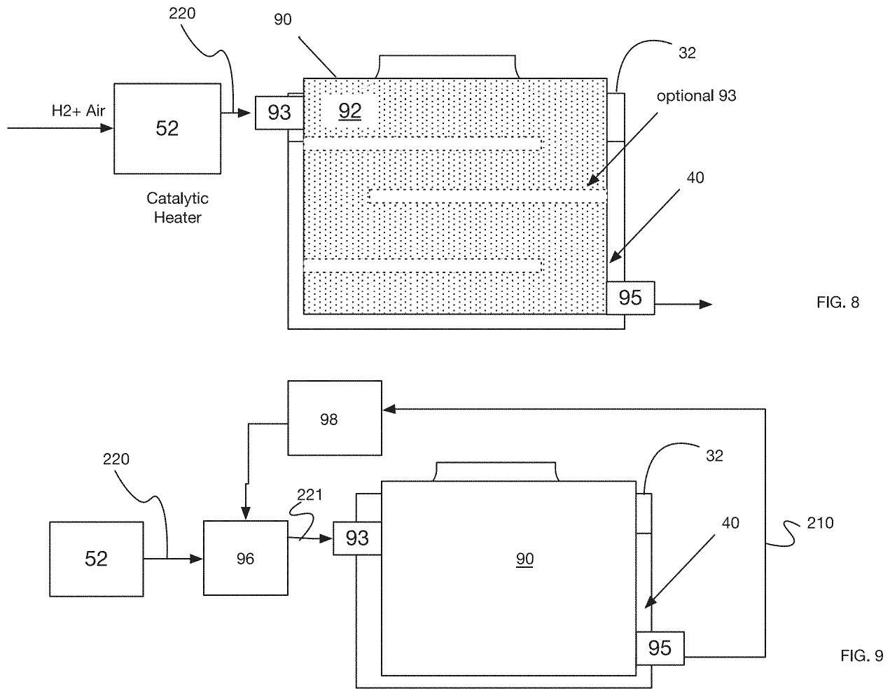

FIGS. 8-10 illustrated aspects of several implementations of catalytic heaters and heating elements combined with jacketed coolant storage tanks.

FIG. 8 illustrates a coolant storage tank 32 containing coolant 40 and which is at least partially surrounded by an outer jacket 90 which may be contoured and adhered to the coolant storage tank. The outer jacket may be insulating to protect the temperature of the coolant storage tank and the coolant therein. The insulation may minimize any heat losses from the coolant supply. The outer jacket may be rigid or flexible. The outer jacket may be composed of a variety of suitable materials and the outer jacket may be multi-layer and may have insulated, non-flammable, materials 92 therein such as metal foams and honeycombs therein. The outer jacket shown in FIG. 8 may optionally contain baffles 93 whereby heated air 220 from a catalytic heater 52 fluidly connected to the inlet 93 of the outer jacket is directed in a predetermined pathway through the outer jacket exiting through an outlet 95.

FIG. 9 illustrates a coolant storage tank 32 containing coolant 40 and which is at least partially surrounded by an outer jacket 90. The outer jacket shown in FIG. 9 may optionally contain baffles whereby heated air is directed in a predetermined pathway through the outer jacket exiting through a fluid pathway 225. In this implementation the catalytic heater 52 is configured to be fluidly connected to a heat transfer exchange medium 96. The heat transfer exchange medium 96 is fluidly connect to the outer jacket. The twice heated air 221 passes from the heat exchange medium 96 to the outer jacket 90 and exits via the outlet 93 which is fluidly connected to the interior space of the outer jacket as a resultant waste stream 210 which is then directed to one of an optional heat exchanger 98 or directly to the heat transfer medium. The heat exchanger 98 may be fluidly connect to the heat transfer medium 96 or it may be in thermal contact with the heat transfer medium. In those instances which include the heat exchanger, at least a portion of the energy in the waste stream is collected and recycled by the heat transfer exchange medium 96.

Those of ordinary skill in the art and the skilled artisan will recognize the addition of recycling the resultant waste stream existing the outer jacket is equally applicable to recycling the waste stream existing tube heaters as previously described and is within the scope of this disclosure.

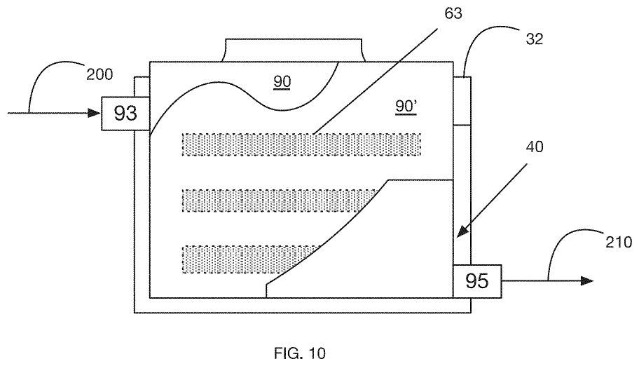

FIG. 10 illustrates a partial cut-away view of a jacketed coolant storage tank 32 containing coolant 40 which is at least partially surrounded by an outer jacket 90. The outer jacket shown in FIG. 10 presents one or more catalytic heating element 55′ within the outer jacket 90 wherein receive a mixture of hydrogen (H2) and air 200 is directed via fluid connection to an inlet 93 in to the outer jacket and exits via the outlet 95. The catalytic heating element 55′ may be a catalyst coasting on at least a portion of the inner jacket surfaces, or it may be presented on substrates within the outer jacket which may be flat strips, metal foams or honey combs.

Catalytic Materials

The above implementations detail the use of catalytic heaters, those heaters may be constructed of a number of different materials. A non-exclusive list of suitable catalytic materials includes metals. The following metals may function as a catalytic material: palladium, platinum, ruthenium, rhodium, osmium, iridium gold, silver, rhenium, iron, chromium, cobalt, copper, manganese, tungsten, niobium, titanium, tantalum, lead, indium, cadmium, tin, bismuth and gallium, among others, as well as compounds and alloys of these metals. In one aspect of the present disclosure, platinum, palladium, rhodium and combinations and alloys thereof are preferred as the catalytic material. In another aspect of the present disclosure, the catalytic material is preferably palladium. Other suitable catalytic materials and metals are generally known to the skilled artisan and/or one of ordinary skill in the art.

The catalytic material preferably spontaneously combusts the fuel source for the fuel cell system (i.e., hydrogen gas) at relatively low temperatures. For example, in some aspects of the disclosure, the catalytic material may combust hydrogen gas at temperatures as low as 0° C. or even as low as −30° C. It may also be useful to select a catalytic material that combusts hydrogen gas safely without an open flame over a broad range of temperatures, including from relatively low temperatures to relatively high temperatures.

The catalytic material is preferably able to induce combustion using relatively low concentrations of hydrogen. In one aspect of the present disclosure, the catalytic heater is configured to combust the hydrogen gas present in the anode exhaust stream. The hydrogen concentration in the anode exhaust stream is relatively low when the fuel cell assembly is operating at a steady state condition. For example, the hydrogen concentration of the anode exhaust may be as low as 1%. The anode exhaust is described in further detail below. Alternatively, the catalytic heater may receive hydrogen gas directly from the hydrogen source. This may be beneficial to the fuel cell system in certain circumstances.

Preferably, the hydrogen gas is pre-mixed with air prior to being introduced to the catalytic heater. The supplied air may be provided by the same air source used for the fuel cell assembly. In this case, the air inlet to the cathode flow field in the fuel cell assembly is fluidly connected to the catalytic heater. Alternatively, the supplied air may be provided from a source separate from the air source for the fuel cell assembly. Fans may be used to direct the air to the coolant module and the catalytic heater. A mixing chamber may be provided upstream of the catalytic heater to mix the supplied air and hydrogen gas. The hydrogen gas mixture is then directed to the catalytic heater where the gas mixture comes in direct contact with the catalytic material thereby triggering the catalytic combustion reaction. The amount of heat generated by the catalytic combustion reaction is largely dependent on the catalytic material, hydrogen concentration in the gas mixture and the flow rate of the gas mixture to the catalytic heater. In some aspects, the gas mixture contains an air to hydrogen ratio of Min: 34:1 (by mass)−stoichiometric ratio; Max: 180:1 (by mass).

Catalytic materials that permit hydrogen to burn at subzero temperatures, however, are particularly advantageous for fuel cell systems operating in colder climates. Platinum-group metals are particularly effective in this regard. As discussed herein, starting-up a fuel cell from subzero or freezing temperatures presents certain challenges. The catalytic heater using the catalytic material disclosed herein will accelerate the cold start-up of the fuel cell system by instantly providing heat to thaw the coolant in the coolant storage tank. In some aspects of the disclosure, the catalytic heater must run for a sufficient amount of time to de-ice the coolant before the coolant is provided to the fuel cell.

In one aspect, the catalytic heater may continuously provide heat to the coolant storage tank to prevent the coolant from freezing. In other words, the catalytic heater may operate separately from the fuel cell to maintain the coolant in the coolant storage tank at a certain operating temperature. The coolant operating temperature may be higher than the freezing temperature of the coolant. Therefore, it is possible to shut down the fuel cell assembly 20 in cold climates while the catalytic heater continues to run thereby ensuring that the coolant does not freeze.

Substrate Support

The catalytic material may be supported on a substrate. For example, the catalytic material may be deposited or coated on a substrate of suitable geometric surface area using methods well known to the skilled artisan and/or those of ordinary skill in the art. Suitable substrates may include, but are not limited to, metals, ceramic materials, and a combination thereof. The substrate may be a porous or foamed material such as a ceramic foam or foamed metal. The substrate may also include structures such as foils, plates, wires, wire meshes, honeycombs, etc. or a combination thereof. The substrate material may assist with dispersing the heat generated by the catalytic combustion of the fuel source.

Coolant Storage Tank

The fuel cell system 10 includes at least one coolant storage tank 32 for storing the coolant supply 40. In some aspects of the present disclosure, the coolant is water. The coolant storage tank may be composed of a variety of suitable materials, including but not limited to, lightweight metal such as aluminum or a high temperature plastic material. FIG. 2 illustrates additional aspects of the coolant storage module. The coolant storage tank may be insulated 33. For example, vacuum insulated panels may be used to insulate the tank. The storage tank may also include suitable venting as needed.

The coolant storage tank is fluidly connected to the fuel cell assembly. The coolant storage tank has an inlet 34 and an outlet 35. The inlet to the storage tank receives coolant from fuel cell assembly 20, which produces water as a by-product of the electrochemical reaction. The outlet of the storage tank discharges coolant to the fuel cell assembly to cool the fuel cell stack 21. The coolant storage tank is thermally connected to the catalytic heater so that at least a portion of the heat generated by the catalytic heater is provided to the coolant in the coolant storage tank.

Hydrogen Source

The fuel cell system 10 includes a hydrogen source 12. The hydrogen source 12 provides hydrogen fuel gas as needed to various parts of the fuel cell system 10. For example, the hydrogen source 12 provides hydrogen fuel gas to the fuel cell assembly 20. The anode side in the fuel cell 20 receives hydrogen gas. The hydrogen source 12 is fluidly connected the anode inlet 22 of fuel cell assembly 20. In some aspects of the present disclosure, the hydrogen source 12 is provided to the coolant tank heater/catalytic heater, the anode exhaust burner and/or the anode exhaust absorber. The fuel cell system 10 may include a hydrogen storage tank (not shown) for storing a supply of hydrogen.

Air Source

The fuel cell system 10 includes an air source 12, which is used to supply the fuel cell assembly 20 with a supply of oxygen. The cathode side of the fuel cell assembly 20 receives the air source 12. The air source 12 is fluidly connected to the fuel cell assembly 20 at the cathode inlet 24. A compressor may be located upstream of the cathode inlet 25 to increase the pressure of the air prior to being introduced to the cathode side of the fuel cell assembly 20.

Coolant Temperature Controller

The controller 100 is configured to monitor the temperature of the coolant in the coolant storage tank and to control operation of the catalytic heating element in response to variations in the coolant temperature in order to maintain coolant temperature above a selected threshold temperature. The threshold temperature may be selected according to the particular application of the fuel cell system and/or the type of coolant used. The threshold temperature selected may generally be higher than the minimum temperature requirement for the coolant so the catalytic heater can come on line and begin to restore the coolant temperature before it drops to a critical level. For example, when water is used as the coolant, the selected threshold temperature may be 15° C. to prevent the water from reaching 0° C. and freezing.

The controller is in fluid contact with the interior of the coolant storage tank using an input line and controls operation of the catalytic heating elements by an output line. Sensors may measure temperature, pressure, current and the like. Said sensors are in signal communication with a controller. The controller is configured to process the sensor output and decision the duty cycle for the heating element(s).

When the coolant temperature drops below the threshold temperature, the controller initiates activation of the catalytic heating elements. While the catalytic heater is in operation, hydrogen gas is fed to the catalytic heating element where it undergoes catalytic combustion, i.e., flameless oxidation of the fuel in the presence of the catalyst. Heat is released from the catalytic combustion and transmitted by radiation from the catalytic heating element to the wall of the coolant storage tank. The heat is then absorbed and conducted to the coolant inside the coolant storage tank, raising the temperature of the coolant.

Oxidant Removal Module

The fuel cell system 10 includes a hydrogen module 90 configured to recover hydrogen fuel present in the anode exhaust and recycle it back to the fuel cell assembly 20. As shown in FIG. 1, the hydrogen module 40 may include a condenser 42 and a water separator 44. The condenser 42 and the water separator 44 may be integrated as a single device, which separates and condenses water from the anode exhaust. Alternatively, the condenser 42 and water separator 44 may be separate devices.

In one aspect, the hydrogen fuel is recycled into the fuel assembly. Recycling the hydrogen gas in the anode exhaust into the hydrogen fuel inlet.

The hydrogen module 40 receives the anode exhaust from the fuel cell assembly 20. The anode exhaust primarily contains water and small amounts of hydrogen. The hydrogen fuel in the anode exhaust may be recovered and recycled back to the fuel cell assembly 20. The used as fuel for the catalytic heater and/or used as fuel for the off-gas burner and anode off-gas absorber heater.

Thermal Module

The fuel cell system includes a thermal module 70 configured to recover water from the cathode exhaust. As shown in FIG. 1 and FIG. 3 the thermal module 70 is fluidly connected to the fuel cell assembly 20 and the coolant module 30. The thermal module 70 includes a condenser 71 and a separator 72. The condenser 71 and the separator 72 may be integrated as a single operation. The condenser 71 may be air cooled or liquid cooled. Alternatively, the condenser 71 may use a combination of air and liquid cooling. For example, the first stage of the condenser 71 may use air cooling and the second stage may use liquid cooling.

Cathode exhaust 27 is directed from the fuel cell assembly 20 to the condenser 71, which serves to liquefy and recover any water vapor in the cathode exhaust. One or more fans 73 may be used to cool the condenser 71 during its operation. The cathode exhaust including condensed water vapor then flows from the condenser 71 to the separator 72. The separator 72 serves to separate the water from any remaining gas in the cathode exhaust. The separator 72 and the condenser may each provide a subwater outlet 74′. A primary water outlet 74 and a gas outlet 76 are fluidly connected to the coolant storage module 30. As the condensed cathode exhaust flows through the separator 72, water is removed and directed to the coolant storage tank 32. Gas from the cathode exhaust stream exits the separator at gas outlet 76 and is vented to the atmosphere.

Exhaust Module

The fuel cell system 10 includes an exhaust module 80 configured to scrub the anode exhaust and remove hydrogen therein. Particularly in the automotive application, emission standard may strictly limit ppm of hydrogen in an exhaust stream. The exhaust module 80 is fluidly connected to the air source 12, the fuel cell assembly 20 and the coolant module 30. The exhaust module 80 includes a compressor 82 and an off-gas burner 84. The off-gas burner may be a catalytic heater 52 as previously described. The exhaust module receives hydrogen gas within the anode exhaust stream and combusts the hydrogen generating heat which may be one or more of exhausted from the system, used for additional applications such as turbine produced electrical power and recycled and used for coolant thawing. Heat exhausted from the coolant module

The exhaust module 80 is fluidly connected to the system and may receive air directly from the air source 12. Such exhaust air passes through the fluid connection via a fan or compressor 82 whereby it is pressurized. The feed from the compressor is provided to the off-gas burner 84. The off-gas burner both diminishes the hydrogen ppm in the exhaust stream and when placed in thermal communication with the absorber module 85 the otherwise lost heat from off-gas combustion is captured and provided to regenerate the oxygen absorbent media 86 packed therein which is more fully described in Applicants co-pending application. The oxygen absorber or oxygen scavenger must be periodically regenerated to remove oxygen captured thereby. Regeneration is accomplished by adding hydrogen to the fluid stream into the exhaust module 80. By heating the oxygen absorbent media 86 sufficiently oxygen hydrogen form water and regenerate the media. The water is carried out of the oxygen absorbent media 86 as water vapor in the gas stream.

The oxygen absorbent media 86 is periodically regenerated during fuel cell operation. At start-up, the anode will contain oxygen which has migrated into the anode and operating (starting up) the fuel cell with such oxygen present will be damaging by corroding the cathode support by raising the cathode potential and thereby oxidizing same which in turn degrades said support and reduces the membrane surface area.

Generally, the off-gas burner may be surrounded with the absorption material and the hydrogen module functions to remove oxygen from the portion of the anode exhaust stream fluidly connected therewith and provide fuel with reduced oxygen for start-up of the fuel cell stack.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

1. A fuel cell coolant supply apparatus, to liberate fluid coolant, the apparatus comprising:
a coolant module configured to supply a coolant to a fuel cell assembly from a coolant storage tank having inner and outer walls; and
one or more catalytic heating elements arranged proximate to the coolant storage tank configured to supply heat to a restricted flow coolant;
wherein the one or more catalytic heating elements include at least a catalyst material that combusts hydrogen on contact; and,
wherein at least one catalytic heating element is mounted or fixed on at least one of portions of the inner wall and portions of the outer wall.

2. A fuel cell coolant supply method, to liberate fluid coolant, the method comprising:
supplying a coolant to a fuel cell assembly from a coolant storage tank using a coolant module;
supplying heat to a restricted flow coolant using one or more catalytic heating elements arranged proximate to the coolant storage tank;
wherein the catalytic heating elements include at least a catalyst material that combusts hydrogen and are configured to accept hydrogen;
wherein hydrogen is provided to the catalytic heating elements from an anode exhaust; and,
wherein the catalytic heating elements reduce the parts per million (ppm) concentration of hydrogen in the anode exhaust stream.

3. A fuel cell system comprising;
a fuel cell assembly having an anode inlet, a cathode inlet, an anode exhaust and a cathode exhaust;
a coolant module configured to provide coolant to the fuel cell assembly;
the coolant module further comprising;
a coolant tank configured to store coolant;
the coolant tank having inner and outer walls and fluidly connected to the fuel cell assembly;
at least one coolant tank heater containing one or more catalytic heating elements arranged in a heat exchange relationship with the coolant storage tank;
the catalytic heating elements having a catalytic material therein;
a means to provide a gaseous fuel supply, for spontaneous catalytic combustion, to the coolant tank heater; and,
wherein the catalyst material is presented on a metallic or ceramic substrate of wire, honeycomb, foam or mesh.

4. The fuel cell system of claim 3, wherein the coolant is water and the gaseous fuel supply includes hydrogen.

5. The fuel cell system of claim 3, wherein the catalyst material provides combustion of hydrogen gas at temperatures at or below −30 degrees C.

6. The fuel cell system of any of claims 3-5, wherein the catalyst material comprises a platinum group metal or alloy.

7. The fuel cell system of any of claims 3-5, wherein the catalyst material comprises palladium, platinum, rhodium and combinations and alloys thereof.

8. The fuel cell system of claim 3, wherein at least one catalytic heating element is mounted or fixed on portions of the inner wall.

9. The fuel cell system of claim 3, wherein at least one catalytic heating element is mounted or fixed on portions of the outer wall.

10. The fuel cell system of claim 3, wherein the coolant storage tank further comprises and outer jacket.

11. The fuel cell system of claim 3, wherein the catalytic heater operates independently of the fuel cell assembly.

12. The fuel cell system of claim 3, further comprising an exhaust module (80) and, wherein the exhaust module configured to scrub the anode exhaust and reduce the PPM concentration of hydrogen therein.

13. The fuel cell system of claim 12, wherein the exhaust module further includes an off-gas burner (84).

14. The fuel cell system of claim 13, further comprising:
an absorber module (85) packed with oxygen absorbent media (86); and, wherein otherwise lost heat from off-gas burner combustion is captured and provided to regenerate the absorbent media configured to absorb oxygen which migrated to the anode.
